(19) United States
(12) Patent Application Publication
(10) Pub. No.: US 2025/0274592 A1
(43) Pub. Date: Aug. 28, 2025

(54) TRANSFORM BLOCK PARTITIONING

(71) Applicant: GOOGLE LLC, Mountain View, CA (US)

(72) Inventors: Jingning Han, Santa Clara, CA (US); Lin Zheng, Waterloo (CA); Yaowu Xu, Saratoga, CA (US)

(21) Appl. No.: 19/061,493

(22) Filed: Feb. 24, 2025

Related U.S. Application Data
(60) Provisional application No. 63/558,846, filed on Feb. 28, 2024.

(51) Int. Cl. H04N 19/176; H04N 19/119; H04N 19/159; H04N 19/70

(52) U.S. Cl. CPC H04N 19/176; H04N 19/119; H04N 19/159; H04N 19/70

(57) ABSTRACT

Disclosed herein are various aspects of systems, methods, and computer readable media for transform block partitioning. Disclosed implementations include decoding a transform block partition type, determining a plurality of sub-blocks for a block based on the decoded transform block partition type, wherein a first sub-block exhibits a different shape and size compared to a second sub-block, performing an intra prediction for the first sub-block to produce a first predictor, performing an inverse transform for the first sub-block to produce a first residual, and generating decoded pixels for the first sub-block using the first predictor and first residual.

### CROSS-REFERENCE TO RELATED APPLICATION(S)

This disclosure claims the benefit of U.S. Provisional Application Ser. No. 63/558,846, filed Feb. 28, 2024, the disclosure of which is incorporated by reference herein in its entirety.

### BACKGROUND

Digital images and video can be used, for example, on the internet, for remote business meetings via video conferencing, high-definition video entertainment, video advertisements, or sharing of user-generated content. Due to the large amount of data involved in transferring and processing image and video data, high-performance compression may be advantageous for transmission and storage. Accordingly, it would be advantageous to provide high-resolution image and video transmitted over communications channels having limited bandwidth.

### SUMMARY

This application relates to decoding video streams for efficient reconstruction of image data. Disclosed herein are various aspects of systems, methods, and computer readable media for transform block partitioning.

An aspect is a method for decoding a video stream. The method includes decoding a transform block partition type, determining a plurality of sub-blocks for a block based on the decoded transform block partition type, wherein a first sub-block exhibits a different shape and size compared to a second sub-block, performing an intra prediction for the first sub-block to produce a first predictor, performing an inverse transform for the first sub-block to produce a first residual, and generating decoded pixels for the first sub-block using the first predictor and first residual.

Another aspect is a video decoding apparatus. The apparatus includes circuitry configured to decode a transform block partition type, determine a plurality of sub-blocks for a block based on the decoded transform block partition type, wherein a first sub-block is distinguished by a different shape and size relative to a second sub-block, perform an intra prediction for the first sub-block to produce a first predictor, perform an inverse transform for the first sub-block to produce a first residual, and generate decoded pixels for the first sub-block using the first predictor and first residual.

Yet another aspect is a non-transitory computer readable medium. The medium includes an encoded bitstream that, when processed by a decoder, produces an output video stream. The decoder is configured to decode a transform block partition type from the encoded bitstream, determine a plurality of sub-blocks for a block based on the decoded transform block partition type, wherein a first sub-block has a different shape and size compared to a second sub-block, perform an intra prediction for the first sub-block to produce a first predictor, perform an inverse transform for the first sub-block to produce a first residual, and generate decoded pixels for the first sub-block using the first predictor and first residual.

Variations in these and other aspects will be described in further detail hereafter.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram of a representation of a portion of a frame in accordance with implementations of this disclosure.

FIG. 7A is an illustration of a first example set of transform block partition types available for partitioning a prediction residual block.

FIG. 7B is an illustration of a second example set of transform block partition types available for partitioning a prediction residual block.

FIG. 8 is a flow diagram of an example technique for decoding an encoded video bitstream.

FIG. 9 is a flow diagram of an example technique for encoding a video stream.

FIG. 10 is a flow diagram of an example technique for decoding an encoded video bitstream.

FIG. 11 is a flow diagram of an example technique for encoding a video stream.

### DETAILED DESCRIPTION

Compression schemes related to coding video streams may include breaking images into blocks and generating a digital video output bitstream using one or more techniques to limit the information included in the output. A received bitstream can be decoded to re-create the blocks and the source images from the limited information. Encoding a video stream, or a portion thereof, such as a frame or a block, can include using temporal or spatial similarities in the video stream to improve coding efficiency. For example, a current block of a video stream may be encoded based on identifying a difference (residual) between certain pixel values in a current frame or in a previously coded frame and those in the current block. In this way, only the residual and parameters used to generate it need be added to the bitstream instead of including the entirety of the current block. This technique may be referred to as inter-prediction (when prediction is performed with respect to a different frame) or intra-prediction (when prediction is performed with respect to pixels in the same frame). The residual may be transformed, e.g., into a frequency domain, by applying a transform such as a discrete cosine transform (DCT) to produce transform coefficients. The transform coefficients may be compressed through quantization and then entropy coded into a compressed video bitstream.

At a decoder, the compressed video bitstream may recover an approximation of the original pixel values and residual by entropy decoding the quantized transform coefficients, inverse transforming the transform coefficients to produce a decoded residual, obtaining a predictor using intra or inter prediction, and then obtaining decoded pixels by combining the residual with the predictor. The decoded residual and decoded pixels may not exactly match the originally encoded pixels due to errors introduced by quantization.

One technique to reduce quantization error and/or reduce the number of bits required to encode the residual is to adaptively change the size of blocks used for prediction and/or transformation. For example, a coding block of a particular size may be partitioned (e.g., subdivided) into smaller sub-blocks for the purpose of inter-prediction, intra-prediction, and/or transformation. Different partitions may be used for prediction and transformation. For example, a coding block may be partitioned according to a first scheme for the purpose of inter-prediction to produce a predictor for a coding block. A residual produced using the predictor may be transformed or decoded transform coefficients may be inverse transformed using a second partitioning scheme different from the first.

A partitioning scheme (e.g., a particular arrangement of sub-blocks having the same or different sizes) may be represented by a transform block partition type. A given video codec (e.g., implemented according to a video coding standard) may have a number of pre-defined transform block partition types that can be selected from by the encoder to sub-divide a block to perform intra-coding and/or transform coding. For example, sub-block residuals (and collectively a residual for the block as a whole) may be generated by producing a predictor for each sub-block using intra-coding and subtracting respective sub-block pixels from respective sub-block predictors. The selected transform block partition type and encoded residuals may then be encoded in a bitstream. When the bitstream is decoded by a decoder, the transform block partition type for a block is decoded and intra decoding and inverse transform is performed for sub-blocks of the block according to the decoded transform block partition type. For example, intra decoding may produce a predictor for each sub-block which may be added to a decoded residual (produced in part by the inverse transform) to generate decoded pixels.

A partitioning scheme may enable, for example, the boundaries of a prediction or a transformation to more closely approximate or follow object boundaries or areas of similar prediction error which may result in a more accurate prediction or a smaller residual resulting in improved compression. The benefits of such partitioning may be constrained however, by the partitions available to the encoder and decoder. For example, an implementation that only provides partitioning schemes having the same sized and/or same shaped sub-blocks may provide less efficient compression than an implementation that provides a partition scheme including differently sized or shaped sub-blocks. The use of differently sized or shaped sub-blocks may enable better matching of statistical variations of pixel values within a block thus enabling better compression efficiency. Implementations of this disclosure utilize partition schemes (e.g., represented by transform block partition types) that include differently sized and shaped sub-blocks (e.g., both square and rectangular) or combinations of partition schemes that include (a) differently sized and shaped sub-blocks and (b) consistently sized and shaped sub-blocks.

In some implementations, a problem relating to a partitioning scheme (e.g., represented by a transform block partition type) that includes differently sized blocks that is used for both intra-coding and transform is that intra-coding is dependent on pixels outside the sub-block (e.g., above and to the left of the sub-block) and thus the ordering of intra-coding of sub-blocks must be arranged so that a sub-block is intra-coded after the pixels needed for intra coding have already been encoded or decoded. Implementations of this disclosure solve this problem by assigning a coding order (e.g., ordering) to a transform block partition type. The intra-coding is then performed according to the coding order of the selected or decoded transform block partition type.

Implementations of this disclosure may support partitioning differently sized blocks into subblocks (e.g., 64×64, 32×32, 16×16, etc.) and one or more transform block partition types may be provided for each of a plurality of different block sizes capable of being partitioned.

Implementations of this disclosure may utilize a pre-defined lookup table where an entry in the lookup table corresponds to a transform block partition type. An entry in the lookup table may include, for example, (a) a number of transform blocks in the block, (b) information indicative of a block size of each sub-block, (c) information indicative of the row and column offset of each sub-block within the block, (d) an identifier of the transform block partition type, (c) a block (e.g., coding block) size to which the transform block partition type is applicable, (f) an ordering of sub-blocks within the block, or (g) subsets or combinations thereof. Encoders and decoders implemented according to this disclosure may utilize such a lookup table to select and encode an indication of a transform block partition type used to encode a block and to determine the characteristics of a transform block partition type decoded from a bitstream in order to permit encoding and decoding by intra-coding, intra-decoding, transform, and/or inverse transform utilizing a partition scheme with ordering without encoding all the characteristics of the partition scheme and ordering in the bitstream.

By way of illustration, differences between an example implementation utilizing same shaped and sized transform blocks for intra-coding and transform and an example implementation utilizing differently shaped and sized transform blocks for intra-coding and transform can be seen in the following example code excerpts:

Same shape / size:
int tx_height = transform height(tx_size);
int tx_width = transform width(tx_size);
int block_height = block_size_height(block_size);
int block_width = block_size_width(block_size);
for (int idy = 0; idy < block_height; idy += tx_height) {

for (int idx = 0; idx < block_width; idx += tx_width) {
process_transform_block(tx_size, idy, idx);
}

}
Different shape / size:
// Pre-define this data structure of the transform block

position information for transform types at both encoder
and decoder. The data structure will be initialized with
appropriate values using the get_txb_info function. Each
sub-block is processed using the process_transform_block
function. Depending on the implementation, intra-coding /
intra-decoding and transform / inverse transform may be
performed within the same function or may be performed
separately using different functions.

typedef struct TXB_POS_INFO {

int row_offset [MAX_TX_PARTITIONS];
int col_offset [MAX_TX_PARTITIONS];
TX_SIZE sub_tx_sizes[MAX_TX_PARTITIONS];
int n_partitions;

} TXB_POS_INFO;
TXB_POS_INFO txb_pos = get_txb_info(block_size,

transform_partition_type);

for (int txb_idx = 0; txb_idx < txb_pos.n_partitions; ++txb_idx)
{

```
process_transform_block(
  txb_pos.sub_tx_sizes [txb_idx],
  txb_pos.row_offset[txb_idx],
  txb_pos.col_offset[txb_idx]);
```

}

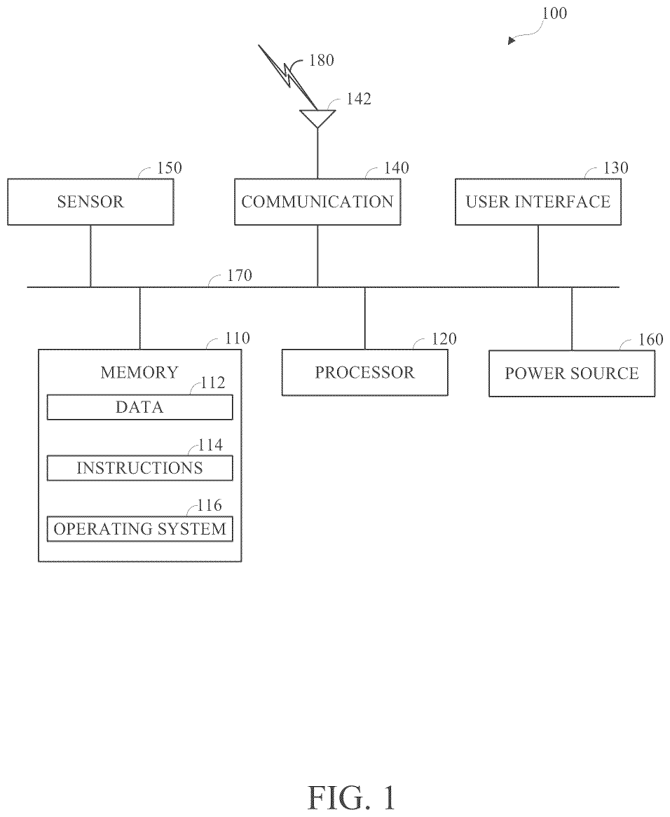

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input audio data, encoded audio data, decoded audio data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, 100 the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

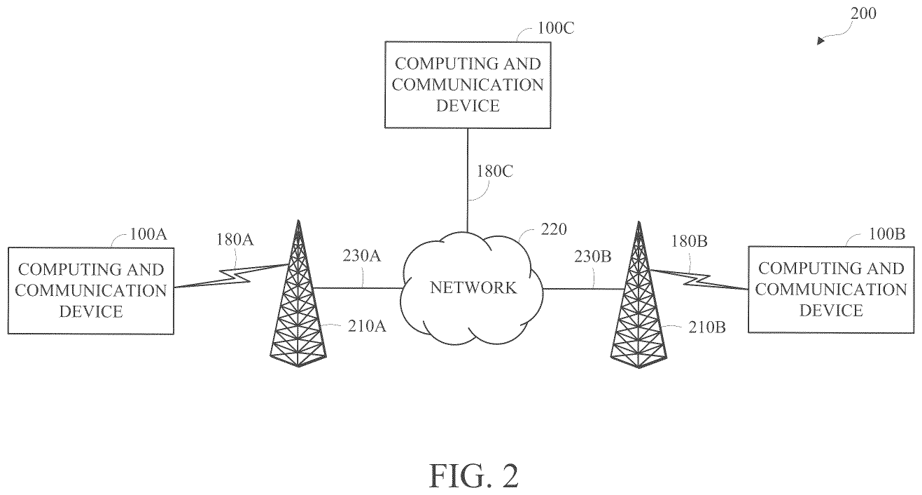

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof video data and one or both of the computing and communication device 100A and the computing and communication device 100B may receive, decode, process, store, present, or a combination thereof the video data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VOIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communication devices, networks, and access points.

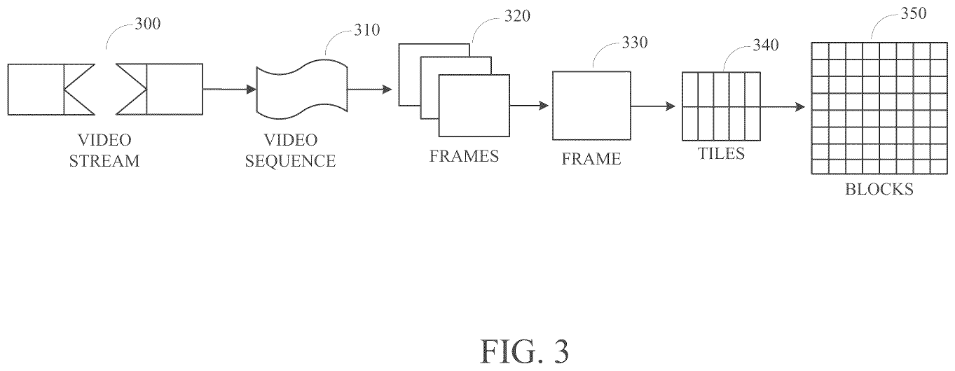

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

A frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. A tile 340 may be a rectangular region of the frame that can be coded independently. Tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

Some implementations may include additional or fewer components than described with respect to FIG. 3. For example, some implementations may not utilize tiles. For example, some implementations may utilize slices or some other intermediate partitioning of a frame instead of tiles. For example, some implementations may utilize different block structures. For example, some implementations may utilize variable block sizes.

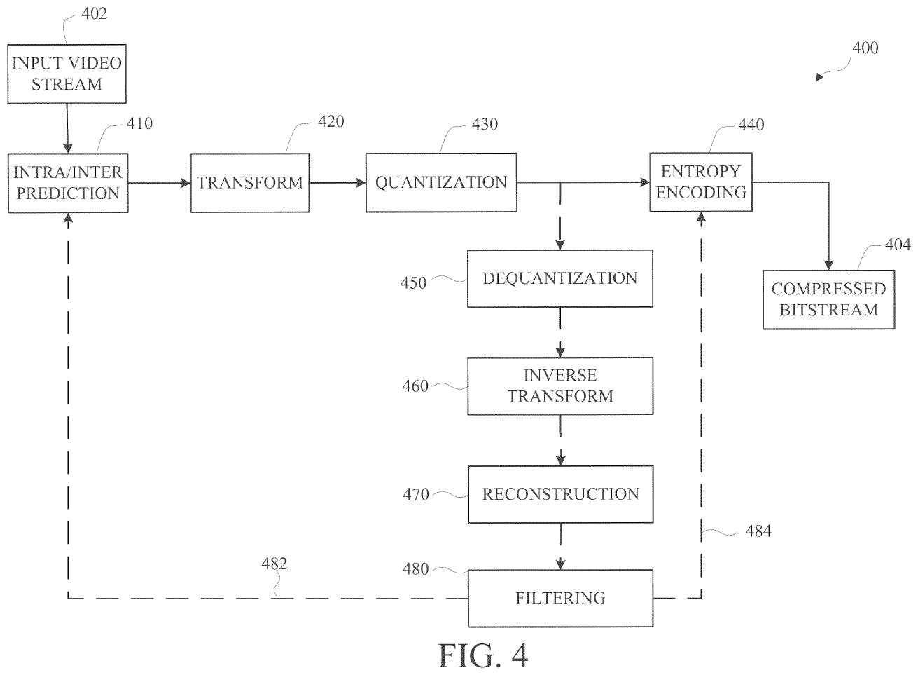

FIG. 4 is a block diagram of an encoder 400 in accordance with implementations of this disclosure. Encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference portion of the reference frame. The motion vector may be generated at a sub-pixel precision. In such a case, interpolation may be utilized to approximate the pixels of the prediction block based on decoded pixels in the reference frame.

The intra/inter prediction unit 410 may subtract the prediction block from the current block (raw block) to produce a residual block. The transform unit 420 may perform a block-based transform, which may include transforming the residual block into transform coefficients in, for example, the frequency domain. Examples of block-based transforms include the Karhunen-Loève Transform (KLT), the Discrete Cosine Transform (DCT), the Singular Value Decomposition Transform (SVD), and the Asymmetric Discrete Sine Transform (ADST). In an example, the DCT may include transforming a block into the frequency domain. The DCT may include using transform coefficient values based on spatial frequency, with the lowest frequency (i.e., DC) coefficient at the top-left of the matrix and the highest frequency coefficient at the bottom-right of the matrix.

The quantization unit 430 may convert the transform coefficients into discrete

quantized values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the block, which may include the type of prediction used, motion vectors, and quantizer values, can be output to the compressed bitstream 404. The compressed bitstream 404 can be formatted using various techniques, such as run-length encoding (RLE) and zero-run coding.

The reconstruction path can be used to maintain reference frame synchronization

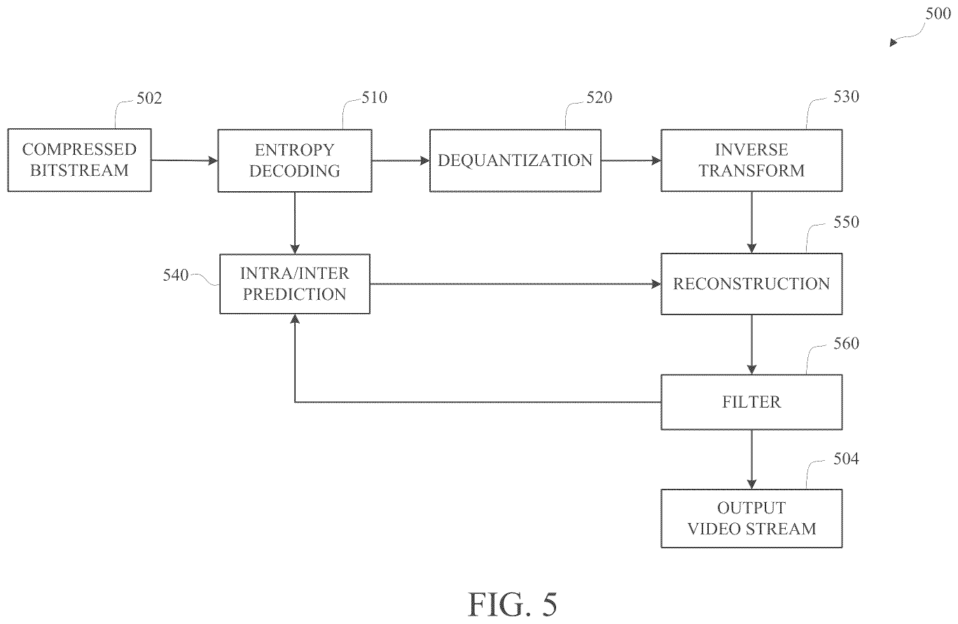

between the encoder 400 and a corresponding decoder, such as the decoder 500 shown in FIG. 5. The reconstruction path may be similar to the decoding process discussed below and may produce an output equivalent to that produced by the decoding process to enable prediction at both the encoder and the decoder to produce the same results. The reconstruction process may include decoding the encoded frame, or a portion thereof, which may include decoding an encoded block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. The reconstructed block may be stored or otherwise made accessible as a reconstructed block, which may be a portion of a reference frame, for encoding another portion of a current frame, another frame, or both, as indicated by the broken line at 482. Coding information, such as deblocking threshold index values, for the frame may be encoded, included in the compressed bitstream 404, or both, as indicated by the broken line at 484.

In implementations of this disclosure, intra-coding, transform, and/or inverse transform may be performed at a sub-block level according to a transform block partition type according to techniques described elsewhere in this specification.

Other variations of the encoder 400 can be used to encode the compressed bitstream 404. For example, a non-transform-based encoder 400 can quantize the residual block directly without the transform unit 420. In some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

In implementations of this disclosure, intra decoding and/or inverse transform may be performed at a sub-block level according to a transform block partition type according to techniques described elsewhere in this specification.

Other variations of the decoder 500 can be used to decode the compressed bitstream 502. For example, the decoder 500 can produce the output video stream 504 without the filtering unit 560.

A video coding standard may specify the requirements to produce a compliant decoder. Such a standard may not specify how to make a video encoder or may provide only certain requirements as to what must be included in a compliant encoder. Instead, an encoder is compliant if it produced a video bitstream that is capable of being decoded by a compliant video decoder. Accordingly, certain tools are implemented to produce the same results in both the encoder and decoder, such as the definition of and utilization of transform block partition types for intra-coding, intra-decoding, transform, and/or inverse transform.

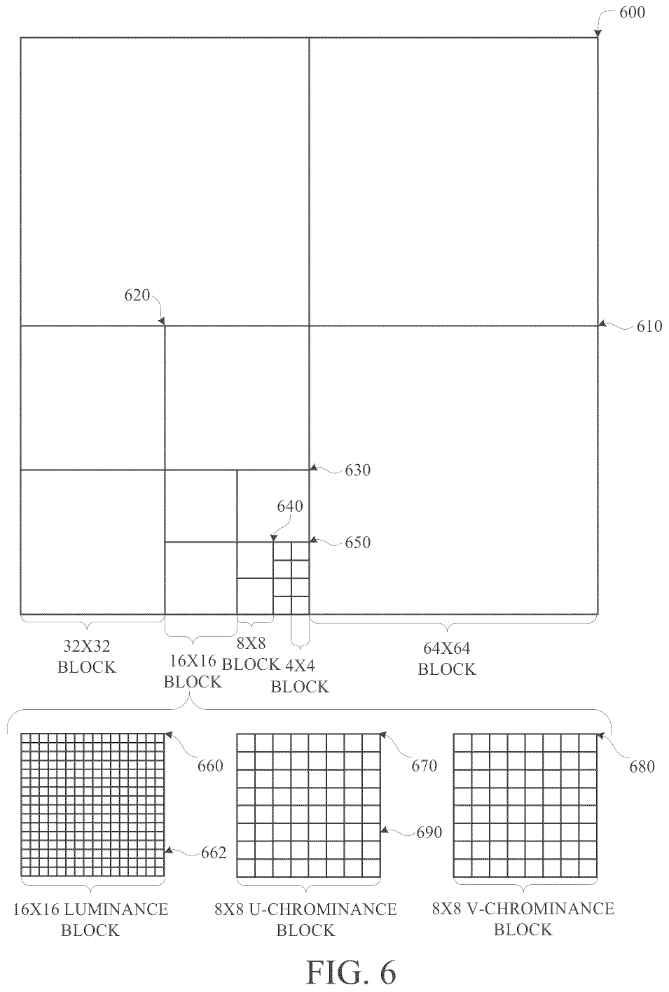

FIG. 6 is a block diagram of a representation of a portion 600 of a frame, such as the frame 330 shown in FIG. 3, in accordance with implementations of this disclosure. As shown, the portion 600 of the frame includes four 64×64 blocks 610, in two rows and two columns in a matrix or Cartesian plane. In some implementations, a 64×64 block may be a maximum coding unit, N=64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16-pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used. For example, 32×64 blocks, 64×32 blocks, 16×32 blocks, 32×16 blocks, or any other size blocks may be used. In some implementations, N×2N blocks, 2N×N blocks, or a combination thereof may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8x8 blocks may be omitted for a 16x16 block, and the 16×16 block may be coded using quad-tree coding wherein the top left 4×4 block may be coded, then the other 4×4 blocks in the 16×16 block may be coded in raster-scan order.

In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame and using a relatively small amount of information to represent each corresponding chrominance component for the portion of the frame. For example, a portion of a frame may be represented by a high-resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different spatial location and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a portion of a reference frame that corresponds to a current block or pixel of a current frame. For example, a reference frame, or a portion of a reference frame, which may be stored in memory, may be searched to identify a portion for generating a prediction to use for encoding a current block or pixel of the current frame with maximal efficiency. For example, the search may identify a portion of the reference frame for which the difference in pixel values between the current block and a prediction block generated based on the portion of the reference frame is minimized and may be referred to as motion searching. In some implementations, the portion of the reference frame searched may be limited. For example, the portion of the reference frame searched, which may be referred to as the search area, may include a limited number of rows of the reference frame. In an example, identifying the portion of the reference frame for generating a prediction may include calculating a cost function, such as a sum of absolute differences (SAD), between the pixels of portions of the search area and the pixels of the current block.

In some implementations, the spatial difference between the location of the portion of the reference frame for generating a prediction in the reference frame and the current block in the current frame may be represented as a motion vector. The difference in pixel values between the prediction block and the current block may be referred to as differential data, residual data, a prediction error, or as a residual block. In some implementations, generating motion vectors may be referred to as motion estimation, and a pixel of a current block may be indicated based on location using Cartesian coordinates as f_{x, y.} Similarly, a pixel of the search area of the reference frame may be indicated based on location using Cartesian coordinates as r_{x, y.} A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two-dimensional data structure such as a matrix as shown, or in a one-dimensional data structure, such as a vector array. In an implementation, a representation of the frame, such as a two-dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block-based coding efficiency may be improved by partitioning input blocks into one or more prediction partitions, which may be rectangular, including square, partitions for prediction coding. In implementations according to this disclosure, prediction partitions may be utilized for performing inter coding and inter decoding (and not intra coding and intra decoding). In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620 the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block-based coding efficiency may be improved by partitioning a current residual block into one or more transform partitions, which may be rectangular, including square, partitions for transform coding. In implementations according to this disclosure, transform partitions (e.g., sub-blocks) may be utilized to perform intra-coding, intra-decoding, transform, and/or inverse transform. In some implementations, video coding, such as video coding using transform partitioning, may include selecting a uniform transform partitioning scheme. For example, a current residual block, such as block 610, may be a 64×64 block and may be transformed without partitioning using a 64×64 transform.

Although not expressly shown in FIG. 6, a residual block may be transform partitioned using a uniform transform partitioning scheme. For example, a 64×64 residual block may be transform partitioned using a uniform transform partitioning scheme including four 32×32 transform blocks, using a uniform transform partitioning scheme including sixteen 16×16 transform blocks, using a uniform transform partitioning scheme including sixty-four 8×8 transform blocks, or using a uniform transform partitioning scheme including 256 4×4 transform blocks.

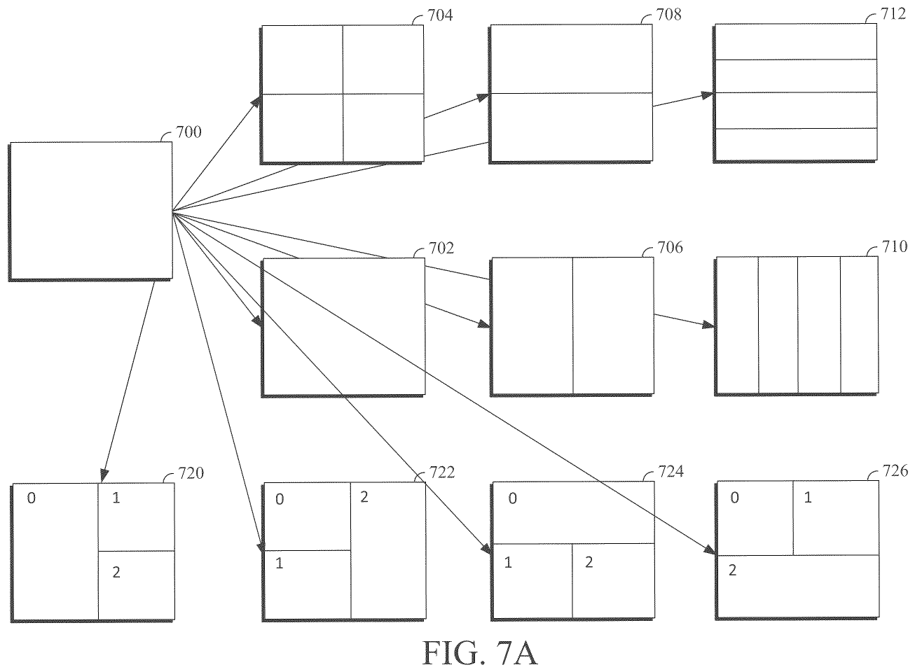

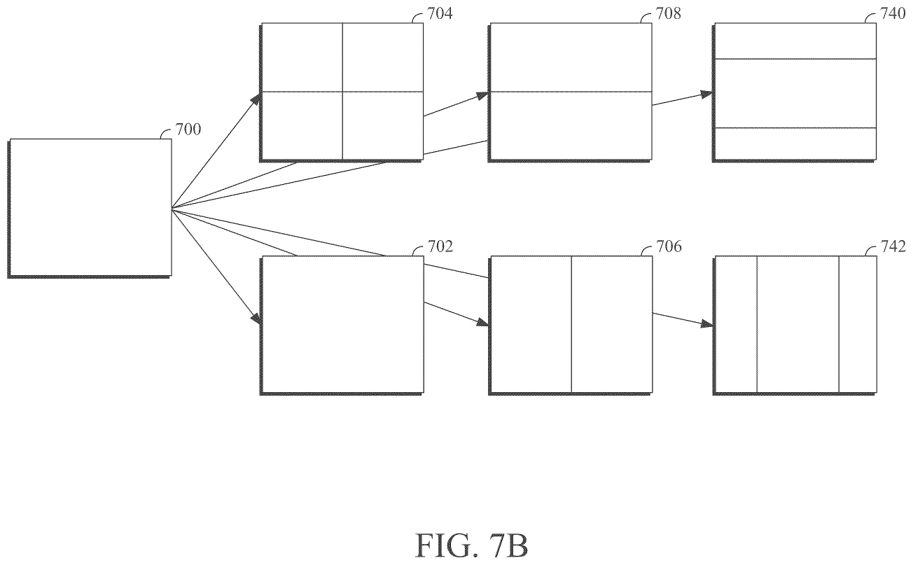

Although not expressly shown in FIG. 6, a residual block may also be transform partitioned using a non-uniform transform partitioning scheme including differently shaped and/or sized transform blocks. Further examples of transform partitioning schemes including uniform and non-uniform partitioning are described with respect to FIG. 7.

As also described elsewhere in this specification, the partitioning of a coding block into transform blocks (e.g., sub-blocks) may be carried out according to a transform block partitioning type and a lookup table may be utilized by the encoder and/or decoder to define the available transform block partitioning types and their associated transform partitioning schemes.

In implementations of this disclosure, the process for selecting a transform partitioning may utilize techniques similar to those described above for identifying a prediction partitioning scheme.

FIG. 7A is an illustration of a first example set of transform block partition types available for partitioning a prediction residual block 700, which may, for example, be the block 610 shown in FIG. 6. The transform block partition types indicate varying shapes and numbers of transform blocks into which the block 700 may be partitioned based on the distribution of video data within block 700.

The use of a first transform block partition type 702 does not result in a partitioning of the block 700. The use of the first transform block partition type 702 thus results in a single transform block which covers the entire block 700. First transform block partition type 702 may be referred to as TX_PARTITION_NONE.

The use of a second transform block partition type 704 results in a four-way partitioning of the block 700. The use of the second transform block partition type 704 thus results in four equally sized transform blocks which each cover one fourth of the block 700. Second transform block partition type 704 may be referred to as TX_PARTITION_SPLIT.

The use of a third transform block partition type 706 results in a two-way vertical partitioning of the block 700. The use of the third transform block partition type 706 thus results in two equally sized transform blocks in which one covers the left portion of the block 700 and the other covers the right portion of the block 700. Third transform block partition type 706 may be referred to as TX_PARTITION_VERT.

The use of a fourth transform block partition type 708 results in a two-way horizontal partitioning of the block 700. The use of the fourth transform block partition type 708 thus results in two equally sized transform blocks in which one covers the top portion of the block 700 and the other covers the bottom portion of the block 700. Fourth transform block partition type 708 may be referred to as TX_PARTITION_HORZ.

The use of a fifth transform block partition type 710 results in a four-way vertical partitioning of the block 700. The use of the fifth transform block partition type 710 thus results in four equally sized transform blocks in which one covers the leftmost portion of the block 700, one covers the left-center portion of the block 700, one covers the right-center portion of the block 700, and the other covers the rightmost portion of the block 700. Fifth transform block partition type 710 may be referred to as TX_PARTITION_VERT4.

The use of a sixth transform block partition type 712 results in a four-way horizontal partitioning of the block 700. The use of the sixth transform block partition type 712 thus results in four equally sized transform blocks in which one covers the topmost portion of the block 700, one covers the top-center portion of the block 700, one covers the bottom-center portion of the block 700, and the other covers the bottommost portion of the block 700. Sixth transform block partition type 710 may be referred to as TX_PARTITION_HORZ4.

The use of a seventh transform block partition type 720 results in a three-way partitioning of the block 700. The use of the seventh transform block partition type 720 results in the use of a rectangular transform block and two square transform blocks.

The use of an eighth transform block partition type 722 results in a three-way partitioning of the block 700. The use of the eighth transform block partition type 720 results in the use of a rectangular transform block and two square transform blocks.

The use of a ninth transform block partition type 724 results in a three-way partitioning of the block 700. The use of the ninth transform block partition type 720 results in the use of a rectangular transform block and two square transform blocks.

The use of a tenth transform block partition type 726 results in a three-way partitioning of the block 700. The use of the tenth transform block partition type 720 results in the use of a rectangular transform block and two square transform blocks.

In some implementations, the first example set comprises the foregoing transform block partition types and one of the types is used for a given block to transform pixels within block 700 and inverse transform coefficients corresponding to block 700.

In some implementations, transform block partition types other than those described above may be used in addition to or instead of those described above.

In implementations according to this disclosure, an ordering may be provided for one or more of the transform block partition types. For example, as depicted with respect to types 720, 722, 724, and 726 (by way of the 0, 1, 2 overlaid on the transform blocks), each transform block (e.g., sub-block) defined by a transform block partition type may have a position in an ordering. The ordering may be utilized, for example, to control an intra-coding or intra-decoding operation on the transform blocks. For example, intra-coding or intra-decoding may be performed first for a transform block having an order of 0, followed by the transform block having an order of 1, followed by a transform block having an order of 1. The ordering may be based on an availability of pixels needed to perform intra-coding or intra-decoding for a given sub-block.

Transform block partitioning types having uniformly partitioned transform blocks may be intra-coded or intra-decoded using a typical raster scan order (e.g., left to right and then top to bottom). The typical raster scan order is not depicted with respect to types 704 to 710. Depending on the implementation, the ordering for uniformly partitioned transform blocks may default to a default ordering (e.g., raster scan order) or may instead be expressly defined in the definition of the associated transform block partitioning type.

FIG. 7B is an illustration of a second example set of transform block partition types available for partitioning a prediction residual block 700, which may, for example, be the block 610 shown in FIG. 6. The transform block partition types indicate varying shapes and numbers of transform blocks into which the block 700 may be partitioned based on the distribution of video data within block 700.

Transform block partition types 702 through 708 may be implemented as described previously with respect to FIG. 7A.

First edge-based transform block partition type 740 results in a three-way horizontal partitioning of the block 700. The use of the first edge-based transform block partition type 740 results in the use of two sub-blocks encompassing the entire width of the block and respectively the top horizontal quarter and bottom horizontal quarter of the block 700 and a third sub-block encompassing the middle horizontal half of the block 700. First edge-based transform block partition type 740 may be referred to as TX_PARTITION_HORZ_M.

Second edge-based transform block partition type 742 results in a three-way vertical partitioning of the block 700. The use of the second edge-based transform block partition type 742 results in the use of two sub-blocks encompassing respectively the left vertical quarter and right vertical quarter of the block 700 and a third sub-block encompassing the middle vertical half of the block 700. Second edge-based transform block partition type 742 may be referred to as TX_PARTITION_VERT_M.

When utilized, the edge-based transform block partition types may result in a quantized residual with less loss than other types in situations where prediction error is different and along the edges of a block as compared to the middle of a block. In other words, the prediction error may be respectively similar across transform coefficients in the middle of the block and edges of the block. For example, predictions at an edge of a block may be more accurate when directional intra prediction is utilized to predict a block. The edge-based transform block partition types may allow for fewer transforms in such a case by permitting a large portion of the middle of the block to be transformed with a single larger transform while the edges of the block are transformed using a smaller, differently sized transform.

In some implementations, the second example set comprises the foregoing transform block partition types 700-708 and 740-742 and one of the types is used for a given block to transform pixels within block 700 and inverse transform coefficients corresponding to block 700.

In some implementations, transform block partition types other than those described above may be used in addition to or instead of those described above.

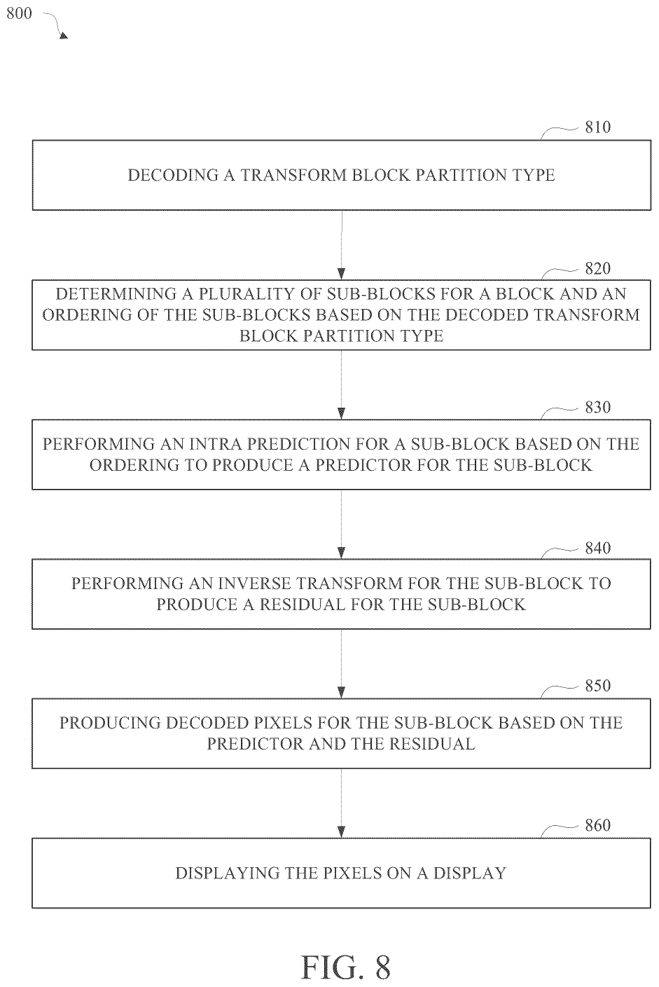

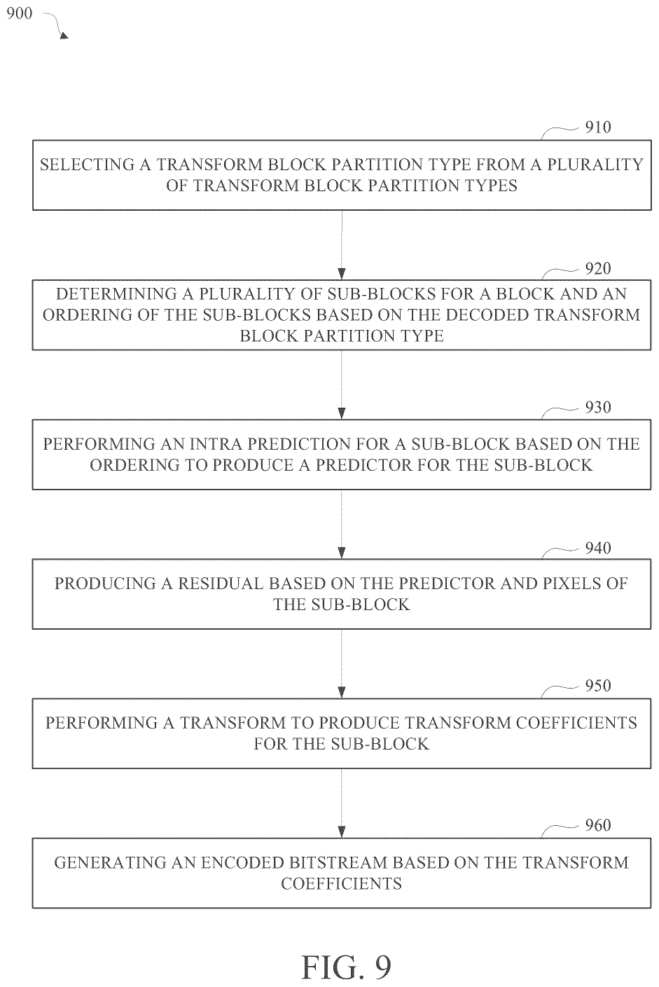

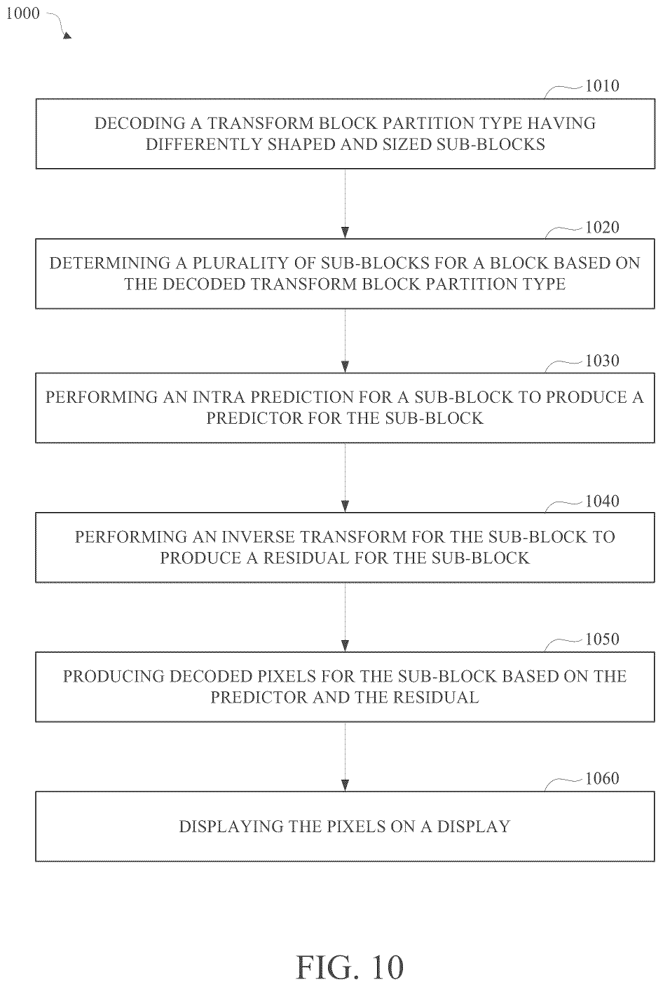

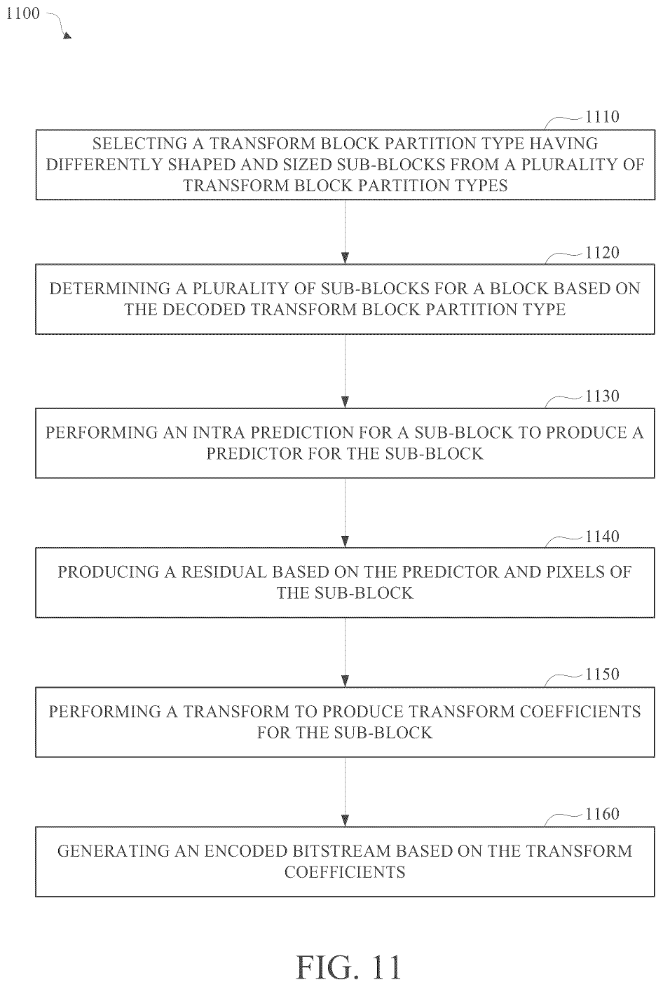

Further details of techniques for video coding and decoding using transform block partitioning types including differently sized and/or shaped transform blocks (e.g., sub-blocks) and/or an ordering of transform blocks (e.g., sub-blocks) are now described. FIG. 8 is a flow diagram of an example technique 800 for decoding an encoded video bitstream. FIG. 9 is a flow diagram of an example technique 900 for encoding a video stream. FIG. 10 is a flow diagram of an example technique 1000 for decoding an encoded video bitstream. FIG. 11 is a flow diagram of an example technique 1100 for encoding a video stream.

Techniques 800, 900, 1000, and/or 1100 can be implemented, for example, as a software program that may be executed by computing devices such as devices 100. For example, the software program can include machine-readable instructions that may be stored in a memory such as the memory 110 and that, when executed by a processor, such as the processor 120, may cause the computing device to perform the technique 800 and/or the technique 900. Techniques 800, 900, 1000, and/or 1100 can be implemented using specialized hardware or firmware. For example, a hardware component may be configured to perform at least a portion of techniques 800, 900, 1000, and/or 1100. As explained above, some computing devices may have multiple memories or processors, and the operations described in techniques 800, 900, 1000, and/or 1100 can be distributed using multiple processors, memories, or both.

An apparatus implementing techniques 800, 900, 1000, and/or 1100 may be implemented using, software, specialized hardware, or a combination thereof. For example, such an apparatus may include circuitry (e.g., a processor or specialized hardware) that performs operations corresponding to steps of techniques 800, 900, 1000, and/or 1100. A video decoding apparatus may be implemented using technique 800 or technique 1000. A video encoding apparatus may be implemented using techniques 800, 900, 1000, and/or 1100.

An encoded video bitstream decodable using technique 800 or technique 1000 or encoded using techniques 800, 900, 1000, and/or 1100 may be stored on a non-transitory computer readable medium such as memory 110. For example, a non-transitory computer readable medium may include an encoded bitstream that, when processed by a decoder using operations corresponding to steps of techniques 800, 900, 1000, and/or 1100, causes the production of an output video stream.

For simplicity of explanation, techniques 800, 900, 1000, and/or 1100 are depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

With respect to technique 800, at step 810, a transform block partition type is decoded. For example, a transform block partition type may be identified by an identifier that is encoded as a symbol in an encoded video bitstream that is decoded by a decoder. The transform block partition type identifier may correspond to an identifier in a row of a lookup table that includes information defining the sub-block sizes, shapes, and locations within a block and the ordering of the sub-blocks. In some implementations, the transform block partition type may be encoded in a series or tree of syntax elements, the combination of which indicates the type to be utilized.

At step 820, a plurality of sub-blocks and an ordering of sub-blocks is determined for a block based on the decoded transform block partition type. For example, an encoder and decoder may include or have access to a lookup table that includes information about transform block partition types as previously described. Information associated with the decoded transform block partition type may be obtained from the lookup table, for example by using an identifier of decoded transform block partition type available both from the decoded transform block partition type and in the lookup table.

At step 830, intra prediction is performed for a sub-block of the plurality of sub-blocks based on the ordering to produce a predictor for the sub-block. For example, the sub-block has an index (e.g., 0, 1, 2) in the ordering and performing intra prediction for the sub-block is conditioned on intra prediction having been completed for sub-blocks earlier in the ordering (e.g. having a smaller index). In other words, the ordering is based on availability of pixels required to perform intra prediction.

At step 840, an inverse transform (e.g., inverse DCT) is performed for the sub-block to produce a residual for the sub-block.

At step 850, decoded pixels for the sub-block are produced using the predictor and the residual. For example, the predictor and residual values may be added in order to obtain the decoded pixels.

At step 860, the decoded pixels are displayed on a display, for example as a part of a decoded video stream that includes the decoded pixels.

The steps of technique 800 may vary depending on the implementation. For example, step 850 may be omitted. For example, steps 830 and 840 may be combined or performed in a manner other than sequentially (e.g., using parallel processing techniques and/or by completing intra-prediction for a block before performing inverse transformation for a block).

With respect to technique 900, at step 910, a transform block partition type is selected from a plurality of transform block partition types. For example, in an encoder 400, multiple transform block partition types may be evaluated and/or tested to determine which transform block partition type should be selected, e.g., in order to obtain better compression results.

At step 920, a plurality of sub-blocks and an ordering of sub-blocks is determined for a block based on the selected transform block partition type. For example, an encoder and decoder may include or have access to a lookup table that includes information about transform block partition types as previously described. Information associated with the selected transform block partition type may be obtained from the lookup table, for example by using an identifier of the selected transform block partition type available both from the selected transform block partition type and in the lookup table.

At step 930, intra prediction is performed for a sub-block of the plurality of sub-blocks based on the ordering to produce a predictor for the sub-block. For example, the sub-block has an index (e.g., 0, 1, 2) in the ordering and performing intra prediction for the sub-block is conditioned on intra prediction having been completed for sub-blocks earlier in the ordering (e.g. having a smaller index).

At step 940, a residual for the sub-block is produced based on the predictor and pixels of the sub-block, for example by subtracting the predictor from pixels of the sub-block.

At step 950, a transform is performed on the residual to produce transform coefficients for the sub-block, for example, by using a DCT transform.

At step 960, an encoded video bitstream is generated based on the transform coefficients. For example, the transform coefficients may be entropy coded and included in the encoded video bitstream as described above with respect to encoder 400. In addition, the selected transform block partition type may be encoded in the encoded video bitstream. The selected transform block partition type may be encoded using an identifier associated with the selected transform block partition type that is capable of being looked up in a lookup table by a decoder. The steps of technique 900 may vary depending on the implementation. For example, steps 910 and 920 may be combined or performed in a different order.

With respect to technique 1000, at step 1010, a transform block partition type having differently shaped and differently sized sub-blocks is decoded. For example, a type corresponding to type 720, type 722, type 724, type 726, type 740, or type 742 may be decoded. For example, a transform block partition type may be identified by an identifier that is encoded as a symbol in an encoded video bitstream that is decoded by a decoder. The transform block partition type identifier may correspond to an identifier in a row of a lookup table that includes information defining the sub-block sizes, shapes, and locations within a block and the ordering of the sub-blocks. In some implementations, the transform block partition type may be encoded in a series or tree of syntax elements, the combination of which indicates the type to be utilized. For example, a first syntax element and a second syntax element may be decoded and the transform block partition type may be determined based on the first syntax element, the second syntax element, an indication of whether horizontal partitioning is allowed, and an indication of whether vertical partitioning is allowed (such an implementation is further described later in this disclosure).

At step 1020, a plurality of sub-blocks is determined for a block based on the decoded transform block partition type. Of the plurality of sub-blocks, a first sub-block has a different shape and a different size as compared to a second sub-block, such as depicted with respect to types 720, 722, 724, 726 and types 740, 742. In some cases, the first sub-block has a first dimension that is one quarter of a first corresponding dimension of the block and the second sub-block has a first dimension that is one half of the first corresponding dimension of the block (e.g., such as shown with respect to types 740, 742). In some cases, the first dimension of the first sub-block, the first dimension of the second sub-block, and the first corresponding dimension of the block each correspond to either a width (e.g., type 740) or a height (e.g., type 742).

For example, an encoder and decoder may include or have access to a lookup table that includes information about transform block partition types as previously described. Information associated with the decoded transform block partition type may be obtained from the lookup table, for example by using an identifier of decoded transform block partition type available both from the decoded transform block partition type and in the lookup table.

At step 1030, intra prediction is performed for a sub-block. For example, intra prediction may be performed in a raster order of the sub-blocks and may be further performed on blocks within the sub-block according to a block size in which intra prediction is performed. In some implementations, an ordering of sub-blocks may be utilized such as previously described.

In implementations of this disclosure, an encoder may be capable of predicting blocks or sub-blocks using intra prediction, inter prediction, or combinations thereof. Accordingly, while some sub-blocks may be predicted using intra prediction, others may be predicted using inter-prediction or other techniques. In such implementations, the unit of prediction (e.g., prediction block or sub-block) may be different than that of the blocks or sub-blocks used for transformation. In such an implementation, a sub-block determined according to a transform block partition type may operate on residual pixels produced by an inter-prediction process for a one or more prediction blocks or sub-blocks that overlap in whole or in part the sub-block determined according to a transform block partition type.

At step 1040, an inverse transform (e.g., inverse DCT) is performed for the sub-block to produce a residual for the sub-block.

At step 1050, decoded pixels for the sub-block are produced using the predictor and the residual. For example, the predictor and residual values may be added in order to obtain the decoded pixels.

At step 1060, the decoded pixels are displayed on a display, for example as a part of a decoded video stream that includes the decoded pixels.

The steps of technique 1000 may vary depending on the implementation. For example, step 850 may be omitted. For example, steps 830 and 840 may be combined or performed in a manner other than sequentially (e.g., using parallel processing techniques and/or by completing intra-prediction for a block before performing inverse transformation for a block).

With respect to technique 1100, at step 1110, a transform block partition type is selected from a plurality of transform block partition types. For example, in an encoder 400, multiple transform block partition types may be evaluated and/or tested to determine which transform block partition type should be selected, e.g., in order to obtain better compression results.

At step 1120, a plurality of sub-blocks is determined for a block based on the selected transform block partition type. For example, an encoder and decoder may include or have access to a lookup table that includes information about transform block partition types as previously described. Information associated with the selected transform block partition type may be obtained from the lookup table, for example by using an identifier of the selected transform block partition type available both from the selected transform block partition type and in the lookup table.

At step 1130, intra prediction is performed for a sub-block of the plurality of sub-blocks based on a raster order to produce a predictor for the sub-block. Intra prediction may be further performed on blocks within the sub-block according to a block size in which intra prediction is performed. In some implementations, an ordering of sub-blocks may be utilized such as previously described.

In implementations of this disclosure, a decoder may be capable of predicting blocks or sub-blocks using intra prediction, inter prediction, or combinations thereof. Accordingly, while some sub-blocks may be predicted using intra prediction, others may be predicted using inter-prediction or other techniques. In such implementations, the unit of prediction (e.g., prediction block or sub-block) may be different than that of the blocks or sub-blocks used for transformation. In such an implementation, a sub-block determined according to a transform block partition type may operate on residual pixels produced by an inter-prediction process for a one or more prediction blocks or sub-blocks that overlap in whole or in part the sub-block determined according to a transform block partition type.

At step 1140, a residual for the sub-block is produced based on the predictor and pixels of the sub-block, for example by subtracting the predictor from pixels of the sub-block.

At step 1150, a transform is performed on the residual to produce transform coefficients for the sub-block, for example, by using a DCT transform.

At step 1160, an encoded video bitstream is generated based on the transform coefficients. For example, the transform coefficients may be entropy coded and included in the encoded video bitstream as described above with respect to encoder 400. In addition, the selected transform block partition type may be encoded in the encoded video bitstream. The selected transform block partition type may be encoded using an identifier associated with the selected transform block partition type that is capable of being looked up in a lookup table by a decoder.

The steps of technique 1100 may vary depending on the implementation. For example, steps 1110 and 1120 may be combined or performed in a different order.

In some implementations of the foregoing techniques, transform block partition types may be signaled using one or a combination of syntax elements and/or constants. For example, such syntax elements and/or constants may include: allow_horiz_partition, allow_vert_partition, txsize_group, txfm_do_partition, txfm_xway_partition_type. A syntax decoding technique may be followed using at least a portion of these syntax elements to determine a transform block partition type.

For example, such a syntax decoding technique may include some or all of the following steps when transform types according to the second example set of transform block partition types are utilized.

In a first step: if both allow_horz_partition and allow_vert_partition (which may be, for example, frame-level syntax elements) are 0, then a TX_PARTITION_NONE transform block partition type is identified (e.g., transform block partition type 702).

Otherwise, in a second step, txfm_do_partition is read. If it is zero, then a TX_PARTITION_NONE transform block partition type is identified (e.g., transform block partition type 702).

Otherwise, in a third step, if both allow_horz_partiton and allow_vert_partition are 1, then a txfm_xway_partition_type (binary value at a block level) is decoded. Either a TX_PARTITION_SPLIT or a TX_PARTITION_VERT_M transform block partition type is identified depending on the value of txfm_xway_partition_type.

Otherwise, in a fourth step, if txsize_group=0, then the TX_PARTITION_HORZ transform block partition type is identified if allow_horz_partition=1 or the TX_PARTITION_VERT transform block partition type is identified if allow_vert_partition=1. The txsize_group may be a constant defined according to the following table based on the block size of the block being partitioned:

| block_size | tx_group |
|---|---|
| BLOCK_4 × 4 | 0 |
| BLOCK_4 × 8 | 0 |
| BLOCK_8 × 4 | 0 |
| BLOCK_8 × 8 | 1 |
| BLOCK_8 × 16 | 2 |
| BLOCK_16 × 8 | 3 |
| BLOCK_16 × 16 | 4 |
| BLOCK_16 × 32 | 5 |
| BLOCK_32 × 16 | 6 |
| BLOCK_32 × 32 | 7 |
| BLOCK_32 × 64 | 8 |
| BLOCK_64 × 32 | 9 |
| BLOCK_64 × 64 | 10 |
| BLOCK_64 × 128 | 10 |
| BLOCK_128 × 64 | 10 |
| BLOCK_128 × 128 | 10 |
| BLOCK_128 × 256 | 10 |
| BLOCK_256 × 128 | 10 |
| BLOCK_256 × 256 | 10 |
| BLOCK_4 × 16 | 11 |
| BLOCK_16 × 4 | 12 |
| BLOCK_8 × 32 | 13 |
| BLOCK_32 × 8 | 14 |
| BLOCK_16 × 64 | 15 |
| BLOCK_64 × 16 | 16 |
| BLOCK_4 × 32 | 11 |
| BLOCK_32 × 4 | 12 |
| BLOCK_8 × 64 | 13 |
| BLOCK_64 × 8 | 14 |
| BLOCK_4 × 64 | 11 |
| BLOCK_64 × 4 | 12 |

Otherwise, in a fourth step, txfm_xway_partition_type is read. The transform block partition type is then identified according to the following table:

| txfm_xway_{—} | allow_{—} | allow_{—} | |
|---|---|---|---|
| partition_{—} | vert_{—} | horz_{—} | |
| type | partition | partition | partition type |
| 0 | 1 | 0 | TX_PARTITION_VERT |
| 0 | 0 | 1 | TX_PARTITION_HORZ |
| 1 | 1 | 0 | TX_PARTITION_VERT_M |
| 1 | 0 | 1 | TX_PARTITION_HORZ_M |

In some implementations, the txfm_xway_partition_type may be entropy coded using a context provided by a cumulative distribution function stored according to xfm_xway_partition_type_cdf[2][16][CDF_SIZE(5)], where the context is provided based on the tx_groups identified above. For example, in such an implementation, different probability table are kept for each tx_group in order to permit a reduction the number of bits required to encode txfm_xway_partition.

Variations of the foregoing decoding process are possible, depending on the implementation.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc., stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g., disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method for decoding a video stream comprising:
decoding a transform block partition type;
determining a plurality of sub-blocks for a block based on the decoded transform block partition type, wherein a first sub-block of the plurality of sub-blocks has a different shape and a different size as compared to a second sub-block of the plurality of sub-blocks;
performing an intra prediction for the first sub-block to produce a first predictor for the first sub-block;
performing an inverse transform for the first sub-block to produce a first residual for the first sub-block; and
generating decoded pixels for the first sub-block using the first predictor and first residual.

2. The method of claim 1, wherein the first sub-block has a first dimension that is one quarter of a first corresponding dimension of the block and the second sub-block has a first dimension that is one half of the first corresponding dimension of the block.

3. The method of claim 2, wherein the first dimension of the first sub-block, the first dimension of the second sub-block, and the first corresponding dimension of the block each correspond to either a width or a height.

4. The method of claim 3, wherein decoding the transform block partition type includes decoding a first syntax element and a second syntax element, and determining the transform block partition type based on the first syntax element, the second syntax element, an indication of whether horizontal partitioning is allowed, and an indication of whether vertical partitioning is allowed.

5. The method of claim 1, further comprising determining an ordering of the sub-blocks based on the decoded transform block partition type, wherein performing the intra prediction for the first sub-block is based on the ordering.

6. The method of claim 5, wherein the ordering is not a raster scan order.

7. The method of claim 6, wherein the ordering is based on availability of pixels required to perform intra prediction.

8. The method of claim 7, wherein determining the plurality of sub-blocks for the block and the ordering of the sub-blocks based on the decoded transform block partition type includes obtaining information from a row of a lookup table including information associated with the decoded transform block partition type.

9. A video decoding apparatus comprising a circuitry that performs operations comprising:
decoding a transform block partition type;
determining a plurality of sub-blocks for a block based on the decoded transform block partition type, wherein a first sub-block of the plurality of sub-blocks has a different shape and a different size as compared to a second sub-block of the plurality of sub-blocks;
performing an intra prediction for the first sub-block to produce a first predictor for the first sub-block;
performing an inverse transform for the first sub-block to produce a first residual for the first sub-block; and
generating decoded pixels for the first sub-block using the first predictor and first residual.

10. The video decoding apparatus of claim 9, wherein the first sub-block has a first dimension that is one quarter of a first corresponding dimension of the block and the second sub-block has a first dimension that is one half of the first corresponding dimension of the block.

11. The video decoding apparatus of claim 10, wherein the first dimension of the first sub-block, the first dimension of the second sub-block, and the first corresponding dimension of the block each correspond to either a width or a height.

12. The video decoding apparatus of claim 11, wherein decoding the transform block partition type includes decoding a first syntax element and a second syntax element, and determining the transform block partition type based on the first syntax element, the second syntax element, an indication of whether horizontal partitioning is allowed, and an indication of whether vertical partitioning is allowed.

13. The video decoding apparatus of claim 9, further comprising determining an ordering of the sub-blocks based on the decoded transform block partition type, wherein performing the intra prediction for the first sub-block is based on the ordering.

14. The video decoding apparatus of claim 13, wherein the ordering is not a raster scan order.

15. The video decoding apparatus of claim 14, wherein the ordering is based on availability of pixels required to perform intra prediction.

16. The video decoding apparatus of claim 15, wherein determining the plurality of sub-blocks for the block and the ordering of the sub-blocks based on the decoded transform block partition type includes obtaining information from a row of a lookup table including information associated with the decoded transform block partition type.

17. A non-transitory computer readable medium including an encoded bitstream that, when processed by a decoder, causes a production of an output video stream, wherein the decoder processes the encoded bitstream using operations comprising:
decoding a transform block partition type from the encoded bitstream;
determining a plurality of sub-blocks for a block based on the decoded transform block partition type, wherein a first sub-block of the plurality of sub-blocks has a different shape and a different size as compared to a second sub-block of the plurality of sub-blocks;
performing an intra prediction for the first sub-block to produce a first predictor for the first sub-block;
performing an inverse transform for the first sub-block to produce a first residual for the first sub-block; and
generating, for the output video stream, decoded pixels for the first sub-block using the first predictor and first residual.

18. The non-transitory computer readable medium of claim 17, wherein the first sub-block has a first dimension that is one quarter of a first corresponding dimension of the block and the second sub-block has a first dimension that is one half of the first corresponding dimension of the block.

19. The non-transitory computer readable medium of claim 18, wherein the first dimension of the first sub-block, the first dimension of the second sub-block, and the first corresponding dimension of the block each correspond to either a width or a height.

20. The non-transitory computer readable medium of claim 19, wherein decoding the transform block partition type includes decoding a first syntax element and a second syntax element, and determining the transform block partition type based on the first syntax element, the second syntax element, an indication of whether horizontal partitioning is allowed, and an indication of whether vertical partitioning is allowed.
